(19) United States
(12) Patent Application Publication
(10) Pub. No.: US 2022/0000305 A1
(43) Pub. Date: Jan. 6, 2022

(54) Apparatus and system for mixing and dispensing accurately pre measured powdered material

(71) Applicant: REBUS CORPORATION PTY LTD., St Arnaud Victoria (AU)

(72) Inventor: Peter John Bloomfield, St Arnaud (AU)

(21) Appl. No.: 15/733,079

(22) PCT Filed: Nov. 14, 2018
(86) PCT No.: PCT/AU2018/000222

§ 371 Date: May 12, 2020

(30) Foreign Application Priority Data
Nov. 23, 2017 (AU) 2017904731

(51) Int. Cl. A47J 31/40; A47J 31/44; A61J 9/00; A61J 11/00; B65D 51/22; B65D 51/28

(52) U.S. Cl. CPC A47J 31/404; A47J 31/4407; A61J 9/008; B65D 51/285; A61J 11/008; B65D 51/22; A61J 11/0095

(57) ABSTRACT

Apparatus and system for mixing and dispensing accurately pre-measured powdered material. The apparatus comprising of a cap, a dispensing teat or similar, a screw down top with a fixed or removable plate insert, a powder keg and a bottle or similar, together with a system, wherein by rotating a screw down top with a fixed or removable plate insert engages a pre-sealed powder keg containing accurately pre-measured powdered material which acts to open and release the accurately pre-measured powdered material into a volume of liquid or similar.

### FIELD OF THE INVENTION

The present invention relates to an apparatus and system for mixing and dispensing accurately pre-measured powdered material, of particular but by no means exclusive application in the sale and consumption of infant powdered formula and protein powdered formula, such as in the infant formula and sports protein powdered market.

### BACKGROUND OF THE INVENTION

Existing methods for accurately mixing and dispensing powdered material involve in each case the operator to calculate and measure the correct dosage of material for each application and across multiple industries. The current available apparatus to perform this activity provides no relief from this existing difficulty and in many instances may exacerbate the potential for miscalculation of correct material to be mixed, of particular but by no means exclusive application which best describes this dilemma is in the sale and consumption of infant powdered formula and protein powdered formula. In both instances, it is the health requirement of the powdered product to be administered with some degree of accuracy when preparing these products for consumption. In all current instances, the degree of accuracy relies entirely upon the user during the preparation of powdered material and if there is any miscalculation there is a large potential for an adverse heath risk. The current applications and systems available provide little if no protection against user miscalculation.

Once again, and with particular reference to the earlier applications, there is also currently little or no opportunity to acquire these powdered products other than in a bulk format i.e. large format tins or similar. Because of this a number of additional problems arise from the current situation, including difficulty in packing and transportation, difficulty in distribution and shelf space and also difficulty in accurately measuring the noted powdered material especially at times when and where the material is most warranted for consumption. In summary to date there has been no convenience or assistance with accurate preparation attached to existing powdered material products.

### SUMMARY OF THE INVENTION

The invention is an all-in-one sterile ready to use pre-measured powdered material apparatus and system. This apparatus and system is completely safe, basic to use requiring no measuring or preparation at all. Components of the apparatus can be disposable and recyclable.

The invention is a convenience product and can be made available for the first time on airplanes, kindergartens, restaurants, schools, hospitals, gyms, convenience stores and can even be available from vending machines at railway stations etc—for brands it is a unique way of conveniently getting their products into the hands of consumers where and whenever the consumer requires it.

The invention is a simple, economical, safe way for consumers to quickly and conveniently mix and dispense powdered material products.

There is no chance of contamination and absolutely no chance of mis-use of material as there is absolutely no preparation, pre-mixing or measuring required.

The apparatus is also disposable and/or can be recycled.

The invention is quick, safe and reliable and for the first time will be readily available when and where the consumer requires it.

The invention has a very long shelf life and requires no refrigeration prior to application.

The invention system consists of attaching a powder keg to a bottle or similar containing a volume of liquid or similar and apply a screw down top comprising of a fixed or removable set of cutting blades. To operate, simply screw down the screw down top in an anti-clock wise direction to the point where the blades engage the powder keg.

Upon this action the powder keg is cut into two components with a ‘dome’ shaped or similar compartment containing the accurately pre-measured powdered material being released into the volume of liquid or similar contained with an attached bottle or similar. The powder keg containing the accurately pre-measured powdered material is prepared and sealed with an air tight non-toxic foil or similar membrane seal lid within a sterile manufacturing facility prior to operation.

The powder keg component is now the correctly dosed convenient and pre-made consumable.

As the powder keg is separated into 2 components during application, there is no potential for the powder keg to be reused or refilled, just the collateral materials can be recycled.

It should be noted that any of the optional or preferred features of any aspect of the present invention may be employed where suitable and desirable with any other aspect of the invention.

### DETAILED DESCRIPTION OF THE DRAWINGS

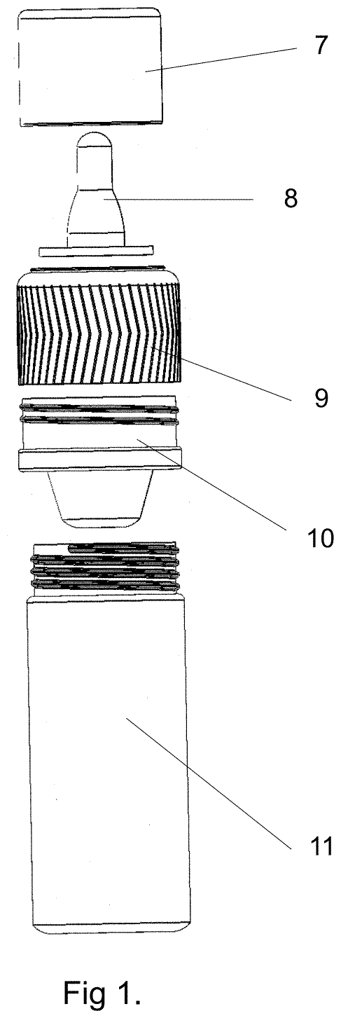

The invention consists of 5 manufactured parts. (please refer to FIG. 1.)
Cap 7
rubber teat or similar 8
Screw down top with a fixed or removable plate insert 9
Powder keg 10
Bottle or similar 11

The entire invention is assembled complete and ready to use in the manufacturing process. This includes the bottle or similar 11 to be filled with a volume of liquid or similar. The powder keg 10 is pre filled with an accurately measured amount of powder material. The powder keg 10 is then completely sealed with an air tight non-toxic foil or similar membrane seal lid.

The rubber teat or similar 8 is positioned within the screw down top 9 which can then be screwed into position over the attached powder keg 10. To ensure that there is no leakage once assembled a small rubber seal maybe included within the screw down top with a fixed or removable plate insert 9 which may enhance the seal when the operator screws down the screw down top with a fixed or removable plate insert 9 during operation of invention. Both the screw down top with a fixed or removable plate insert 9 and the powder keg 10 have notches in the thread to engage the system of the invention and will lock into position at the commencement of rotation. This acts as a physical alert to inform that the invention is now ready for operation.

Finally the cap 7 is put into position over the rubber teat or similar 8 and the entire top section may be protected by an tamper evident plastic seal for market.

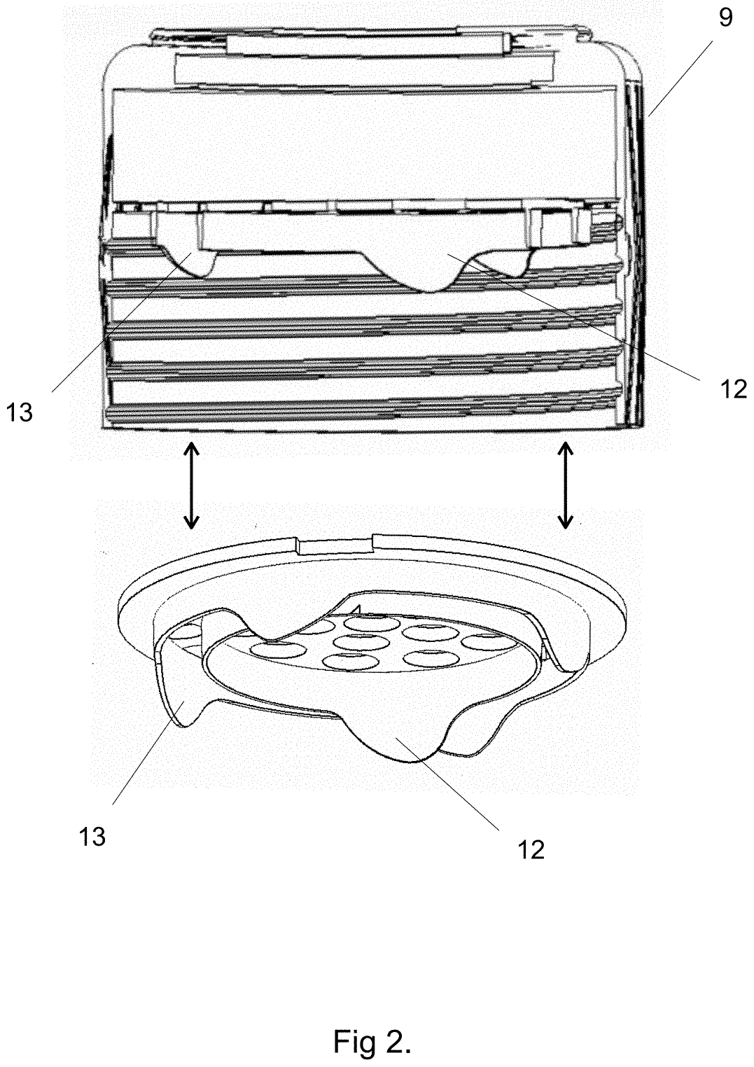

The screw down top with a fixed or removable plate insert 9 (refer FIG. 2) consists of a set of 2 inner and concentric cutting blades. The inner cutting blade 12 is a single protruding blade and the outer blades 13 consists of a set of 4 evenly spaced protruding blades. When the screw down top with a fixed or removable plate insert 9 is rotated anti-clockwise it moves downwards and performs an internal parallel cutting action by engaging the two sets of concentric blade 12,13 wherein the first inner single blade 12 firstly engages and breaks the powder keg 10 inner seal and creates a three quarter cut into the air tight non-toxic foil or similar membrane seal lid on the powder keg 10, whilst simultaneously the set of 4 outer cutting blades 13 then breaks the outer powder keg 10 along a fabricated scoreline to allow the powder keg 10 to firstly open and then seperate along the fabricated scoreline allowing the ‘dome’ shaped or similar receptacle containing the pre-measured powder to fall into the volume of liquid or similar below in the bottle or similar 11. The size, shape and position of these concentric cutting blades 12, 13 is specifically designed for the efficient opening and then separation of the powder keg 10 into the two components and efficiently release the pre-measured powder material.

The invention is then simply shaken to mix the released powder with the volume of liquid or similar contained in the bottle or similar 11.

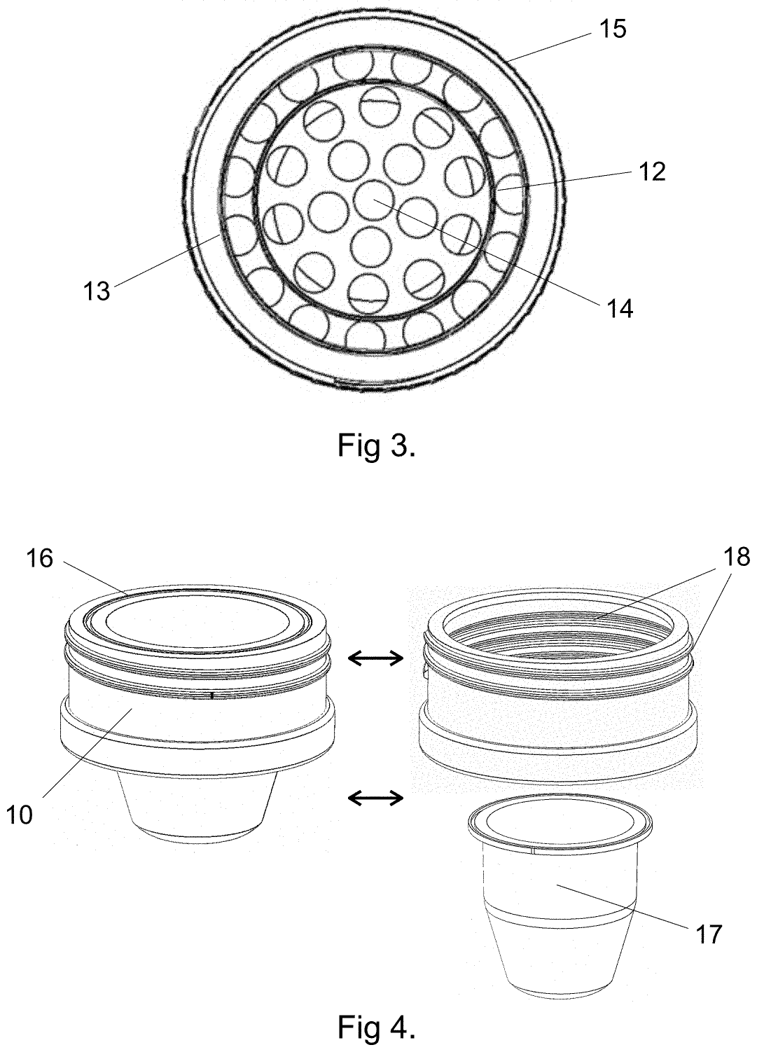

The screw down top with a fixed or removable plate insert 9 (refer FIG. 3) also includes an anti-glugging shield 14 located at the inner section of the screw down top with a fixed or removable plate insert 9. The anti-glugging shield 14 comprises a plate with a series of large circular holes to allow steady flow of mixed powdered material, however also ensures that in the potential event any part remains unmixed or gluggy, the unmixed powdered material does not find its way into the rubber teat or similar 8 section. This stops blockages occurring within the rubber teat or similar 8. The outside of the screw down top with a fixed or removable plate insert 9 contains a series of directional ridges 15 to indicate direction of use and to ensure enhanced operation.

The powder keg 10 (refer FIG. 4) also includes novelty inventions including a pre-measured powdered material dose placed in a ‘dome’ shaped or similar receptacle 17 and is then sealed with an air tight non-toxic foil or similar membrane. The ‘dome’ shaped or similar receptacle 17 is connected to the outer rim of the powder keg 10 by a fabricated scoreline connection 16 at the very top of the powder keg 10. The outer set of cutting blades 13, located within the screw down top with a fixed or removable plate insert 9, when operated perform a cut along this fabricated scoreline 16 which in turn separates the powder keg 10 into two components during operation. The ‘dome’ shaped or similar receptacle 17 is specifically designed to not ‘float’ when it is separated and drops into the volume of liquid or similar within the bottle or similar 11 and instead will topple to one side to ensure rapid mixing of powdered material. The ‘dome’ shaped or similar receptacle 17 is also specifically designed to aid in the mixing process when the invention is shaken during operation.

The screw down top with a fixed or removable plate insert 9 and the powder keg 10 (refer FIG. 4) involve an innovative set of inner and outer reverse threading 18. This means that when the screw down top with a fixed or removable plate insert 9 is connected to the powder keg 10 via the reverse threading 18, when turned from left to right the top moves in a downward direction to engage the inner cutting blade 12 and the outer cutting blades 13. The usual direction on any threaded lid when turned from left to right is in an upward direction—i.e. the lid comes off.

Once the invention is used it cannot be reassembled for refilling as the powder keg 10 breaks into two components—this is critical to ensure that rogue traders do not substitute powder material and there is no way that contamination of product can occur once it has left the factory.

1. An apparatus and system, comprising of;
a cap;
a dispensing teat or similar;
a screw down top with a fixed or removable plate insert;
a powder keg; and
a bottle or similar.

2. An apparatus as claimed in claim 1, comprising a cap for covering the dispensing teat or similar.

3. An apparatus as claimed in claim 2, comprising a dispensing teat or similar for distribution of mixed powdered material.

4. An apparatus as claimed in any one of claims 1 to 3, comprising a screw down top which includes a fixed or removable plate insert.

5. An apparatus as claimed in claim 4, wherein said fixed or removable plate insert comprises a set of inner and outer concentric cutting blades.

6. An apparatus as claimed in either claim 4 or 5, wherein said inner concentric cutting blade comprises a single protruding blade.

7. An apparatus as claimed in any one of claims 4 to 6, wherein said outer concentric cutting blade comprises a set of four, evenly spaced along the concentric blade, protruding blades.

8. An apparatus as claimed in any one of claims 2 to 7, wherein said set of inner and outer concentric cutting blades are set such that the protruding blade of the inner concentric cutting blade, consisting of the single protruding blade, is set to be nominally larger than all of the four evenly spaced, protruding cutting blades of the outer concentric cutting blade.

9. An apparatus as claimed in claim 4, wherein said fixed or removable plate insert also comprising a series of evenly spaced holes, emanating from the centre point.

10. An apparatus as claimed in any one of claims 4 to 9, wherein said fixed or removable plate insert may be weld fixed into position within the screw down top or may be removed and then restored or replaced into position via locating pins within the screw down top.

11. An apparatus as claimed in any one of claims 1 to 10, comprising a powder keg.

12. An apparatus as claimed in claim 11, wherein said powder keg comprises a fabricated outer scoreline or similar cut line on the top surface.

13. An apparatus as claimed in either claim 11 or 12, wherein said powder keg comprises a dome shaped or similar receptacle.

14. An apparatus as claimed in any one of claims 11 to 13, wherein said dome shaped or similar receptacle contains an accurately pre-measured powdered material.

15. An apparatus as claimed in any one of claims 11 to 14, wherein said powder keg comprises an air tight non-toxic foil or similar membrane seal lid.

16. An apparatus as claimed in any one of claims 11 to 15, wherein said powder keg comprises an inner and outer reverse thread.

17. An apparatus as claimed in any one of claims 1 to 16, comprising a bottle or similar.

18. An apparatus as claimed in any one of claims 1 to 17, wherein the the inner thread of the screw down top with a fixed or removable plate insert includes a locking notch.

19. An apparatus as claimed in either claim 16 or 18, wherein the the outer thread of the powder keg includes a corresponding locking notch to that of the locking notch located on the inner thread of the screw down top with a fixed or removable plate insert.

20. An apparatus as claimed in any one of claims 1 to 19, wherein said screw down top which includes a fixed or removable plate insert attaches to said powder keg via a reverse screw down thread and said powder keg attaches to said bottle or similar via a similar reverse screw down thread.

21. An apparatus as claimed in any one of claims 1 to 20, wherein said bottle or similar comprises a volume of liquid or similar.

22. A system wherein by rotating a powder keg in an anti-clockwise direction attaches the powder keg to a bottle or similar.

23. A system as claimed in claim 22, wherein by rotating a screw down top with a fixed or removable plate insert in an anti-clockwise direction on the reverse threading of the attached powder keg, moves the screw down top in a downward direction.

24. A system as claimed in either claim 22 or 23, wherein by rotating a screw down top with a fixed or removable plate insert, the corresponding locking notch located on the inner thread of the screw down top with the fixed or removable plate and the locking notch located on the outer thread of the powder keg interact to indicate that any further rotation of the screw down top with the fixed or removable plate insert and the system will commit to engage.

25. A system as claimed in any one of claims 22 to 24, wherein by rotating a screw down top with a fixed or removable plate insert beyond the locking notch engages the set of inner and outer concentric cutting blades with a powder keg.

26. A system as claimed in any one of claims 22 to 25, wherein at the point of engagement between the fixed or removable plate with the said set of inner and outer concentric cutting blades and the said powder keg, a concentric three quarter cut is made firstly within the air tight non-toxic foil or similar membrane seal lid of the said powder keg and a second and concurrent complete cut is made by the outer concentric cutting blades along the outer fabricated scoreline or similar on the top surface of the said powder keg.

27. A system as claimed in any one of claims 22 to 26, wherein once a full rotation of the screw down cap with a fixed or removable plate insert is completed beyond the corresponding locking notches, the said powder keg is separated into two pieces along the fabricated scoreline or similar, opening and releasing the dome shaped or similar receptacle.

28. A system as claimed in claim 26, wherein once the dome shaped or similar receptacle is opened and released, the accurately pre-measured powdered material contained within the powder keg is allowed to mix with a volume of liquid or similar contained within an attached bottle or similar.

29. A system as claimed in any one of claims 22 to 28, wherein said fixed or removable plate insert comprising a series of evenly spaced holes, emanating from the centre point, act to reduce the consistency of any un-mixed powdered material.

30. A system as claimed in any one of claims 22 to 29, wherein the said powder keg is pre-loaded with accurately pre-measured powdered material and pre-sealed with an air tight non-toxic foil or similar seal lid.
